(19) United States
(12) Patent Application Publication
(10) Pub. No.: US 2022/0315085 A1
(43) Pub. Date: Oct. 6, 2022

(54) PORTABLE LOAD LIFT DEVICE

(71) Applicant: Anand Parthasarathy, Cypress, TX (US)

(72) Inventor: Anand Parthasarathy, Cypress, TX (US)

(21) Appl. No.: 17/712,753

(22) Filed: Apr. 4, 2022

Related U.S. Application Data
(60) Provisional application No. 63/170,474, filed on Apr. 3, 2021.

(51) Int. Cl. B62B 3/04; B66C 13/16; B66C 13/22; B66C 23/62

(52) U.S. Cl. CPC B62B 3/04; B66C 13/16; B66C 13/22; B66C 23/62; B62B 2203/10

(57) ABSTRACT

A load lifting device is provided that includes a cart, a powered winch, and controls. The cart has a base with a plurality of rollers, an upright frame, and a winch arm. The base has a forward end and an aft end. The upright frame has a base end and a distal upper end. The base end of the upright frame is attached to the base proximate the aft end. The winch arm extends out from the upright frame proximate the upper end. The powered winch is controllable to selectively play out or draw in a lift line. The powered winch is attached to the winch arm and is in communication with a source of electrical power. The controls are configured for operating the powered winch to play out or draw in the lift line.

This application claims priority to U.S. Patent Application No. 63/170,474 filed Apr. 3, 2021, which is hereby incorporated by reference in its entirety.

### BACKGROUND

### 1. Technical Field

The present disclosure relates to apparatus for lifting items in general, and to powered apparatus for lifting items in particular.

### 2. Background Information

There are many instances when an item needs to be picked up from a first position, moved to second position, and deposited on a surface such as the ground. As the weight and/or the bulkiness of the item increases, the difficulty of moving that item also increases. In addition, in many instances there is a desire to move that item in a controlled manner to ensure no damage is done to the item in the process. What is needed is a powered apparatus that can be used to pick up an item from a first position, move it to a second position, and deposit the item on a surface in a controlled manner, and one that can be configured as a portable device.

### SUMMARY

According to an aspect of the present disclosure, a load lifting device is provided that includes a cart, a powered winch, and controls. The cart has a base with a plurality of rollers, an upright frame, and a winch arm. The base has a forward end and an aft end. The upright frame has a base end and a distal upper end. The base end of the upright frame is attached to the base proximate the aft end. The winch arm extends out from the upright frame proximate the upper end. The powered winch is controllable to selectively play out or draw in a lift line. The powered winch is attached to the winch arm and is in communication with a source of electrical power. The controls are configured for operating the powered winch to play out or draw in the lift line.

In any of the aspects or embodiments described above and herein, the cart may be configurable in an operational configuration wherein an entirety of the upright frame extends upwardly from the base, and in a folded configuration wherein less than the entirety of the upright frame extends upwardly from the base.

In any of the aspects or embodiments described above and herein, the upright frame may include a first portion attached to the base and a second portion attached to the first portion by one or more foldable joints.

In any of the aspects or embodiments described above and herein, the load lifting device may include one or more support members extending between the upright frame and the base adjacent the aft end, wherein the one or more support members may be selectively detachable from the base and upright frame.

In any of the aspects or embodiments described above and herein, the load lifting device may include one or more support members extending between the upright frame and the base adjacent the aft end, wherein the one or more support members include a foldable joint.

In any of the aspects or embodiments described above and herein, the winch arm may include an attachment end and a distal end. The attachment end may be pivotally attached to the upright frame to permit the distal end of the winch arm to selectively be moved laterally towards a first lateral side of the base or to a second lateral side of the base, wherein the second lateral side of the base is opposite the first lateral side.

In any of the aspects or embodiments described above and herein, the base may include a first side rail disposed on a first lateral side of the base, a second side rail disposed on a second lateral side of the base, wherein the first lateral side of the base is opposite the second lateral side of the base, and a platform that extends between the first side rail and the second side rail.

In any of the aspects or embodiments described above and herein, the platform may include an aft section and a forward section. The forward section has a first end disposed adjacent the aft section and an opposite distal end. The first end of the forward section of the platform may be pivotally attached to the base to permit the distal end of the forward section to be selectively rotated between a platform position where the distal end of the forward section is aligned with the first side rail and the second side rail, and a stowed position wherein the distal end of the forward section is rotated back towards the upright frame.

In any of the aspects or embodiments described above and herein, the platform may include a first end and a distal end. The first end may be pivotally attached to the base to permit the distal end of the platform to be selectively rotated between a platform position where the distal end of the platform is aligned with the first side rail and the second side rail, and a stowed position wherein the distal end of the platform is rotated back towards the upright frame.

In any of the aspects or embodiments described above and herein, the base may include at least one platform extension disposed on the first lateral side of the base and extend laterally outward from the first side rail, or the platform extension may be disposed on the second lateral side of the base and extend laterally outward from the second side rail.

In any of the aspects or embodiments described above and herein, the base may include a first platform extension disposed on the first lateral side of the base and extend laterally outward from the first side rail, and a second platform extension disposed on the second lateral side of the base and extend laterally outward from the second side rail.

In any of the aspects or embodiments described above and herein, the source of electrical power may be a portable source of stored electrical power or a source of AC power.

In any of the aspects or embodiments described above and herein, the base may include a first lateral side and a second lateral side, wherein the first lateral side is opposite the second lateral side, and the device further may include a first outrigger disposed on the first lateral side and a second outrigger disposed on the second lateral side.

In any of the aspects or embodiments described above and herein, the load lifting device may include a load weighing device configured to determine a magnitude of a load lifted by the powered winch.

According to another aspect of the present disclosure, a load lifting device is provided that includes an attachment base, at least one arm segment, a powered winch, and controls. The attachment base is configured for selective attachment to a surface. The at least one arm segment is pivotally attached to the attachment base. The powered winch is attached to the at least one arm segment. The powered winch is controllable to selectively play out or draw in a lift line and is in communication with a source of electrical power. The controls are configured for operating the powered winch to play out or draw in the lift line.

In any of the aspects or embodiments described above and herein, the load lifting device may include at least one moveable support attached to the at least one arm segment. The at least one moveable support is configured to support the at least one arm segment.

In any of the aspects or embodiments described above and herein, the at least one arm segment may include a first arm segment (FAS) and a second arm segment (SAS). The FAS extends lengthwise between a FAS first end and a FAS second end, and the SAS extends lengthwise between a SAS first end and a SAS second end. The FAS first end of the FAS is pivotally attached to the attachment base and the FAS second end is pivotally attached to the SAS first end of the SAS. The powered winch may be attached to the SAS.

In any of the aspects or embodiments described above and herein, the load lifting device may include at least one moveable support attached to the FAS or the SAS, the at least one moveable support configured to support at least one of the FAS or the SAS.

In any of the aspects or embodiments described above and herein, the at least one moveable support may include at least one roller attached to the FAS and at least one roller attached to the SAS.

In any of the aspects or embodiments described above and herein, the load lifting device may include a load weighing device configured to determine a magnitude of a load lifted by the powered winch.

The foregoing has outlined several aspects of the present invention in order that the detailed description of the invention that follows may be better understood. Additional features and advantages of the invention will be described hereinafter which form the subject of the claims of the invention.

### BRIEF DESCRIPTION OF THE DRAWINGS

FIG. 1 is a diagrammatic side view of a present disclosure load lift device.

FIG. 2 is a diagrammatic front view of the present disclosure load lift device shown in FIG. 1.

FIG. 3 is a diagrammatic top view of the present disclosure load lift device shown in FIG. 1, sectioned along the line 3-3.

FIG. 4 is a diagrammatic perspective view of a present disclosure load lift device.

FIG. 5 is a diagrammatic top view of the present disclosure load lift device shown in FIG. 1, sectioned along the line 3-3, now including lateral base extensions.

FIG. 6 is a diagrammatic perspective view of a present disclosure load lift device.

FIG. 7 is a diagrammatic side view of a winch arm embodiment.

FIG. 8 is a diagrammatic side view of a winch arm embodiment.

FIG. 9 is a diagrammatic perspective view of a present disclosure load lift device.

FIG. 10 is a diagrammatic side view of a winch arm embodiment.

FIG. 11 is a diagrammatic top view of the present disclosure load lift device shown in FIG. 1, sectioned along the line 3-3, now including outriggers.

FIG. 12 is a diagrammatic perspective view of a present disclosure load lift device.

FIG. 13 is a diagrammatic top view of a present disclosure load lift device.

FIG. 14 is a diagrammatic side view of the present disclosure load lift device shown in FIG. 13.

FIG. 15 is a diagrammatic top view of a present disclosure load lift device.

FIG. 16 is a diagrammatic perspective view of a present disclosure load lift device.

### DETAILED DESCRIPTION

The present disclosure is directed to a load lifting device. In some embodiments the load lifting device is configured as movable cart 22 and other embodiments are configured to be mounted to a stationary surface. The load lifting device may be configured as a portable device.

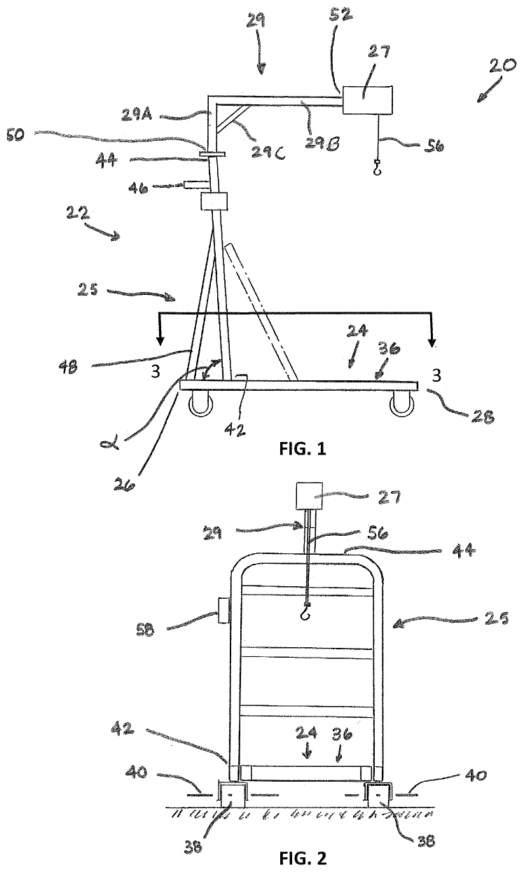

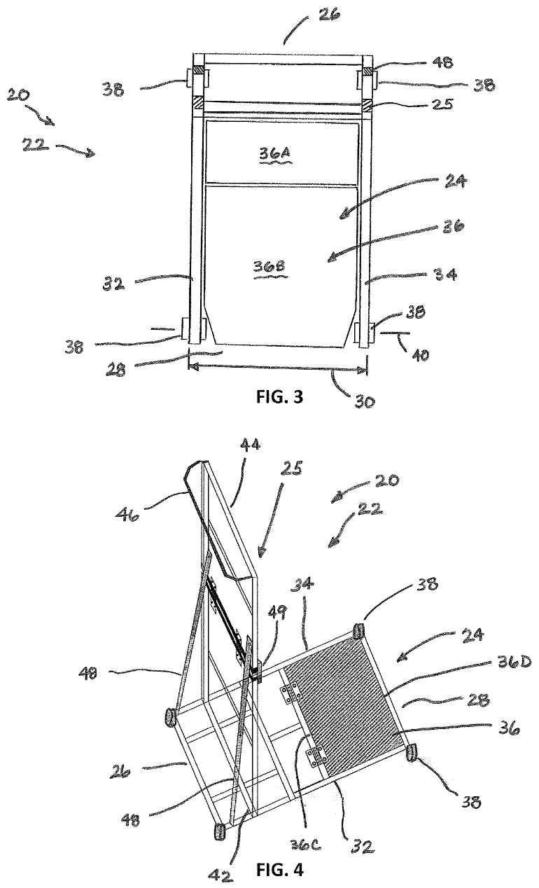

Referring to FIGS. 1-3, a load lifting device 20 embodiment configured as a movable cart 22 may include a base 24, an upright frame 25, a powered winch 27, and an arm for supporting the powered winch 27 (i.e., a “winch arm 29”). The base 24 has an aft end 26, a forward end 28, and a width 30. The base 24 may include a first side rail 32 disposed on a first lateral side and a second side rail 34 disposed on a second lateral side. A platform 36 is disposed between and attached to the first and second side rails 32, 34. The platform 36 may be a unitary structure or it may include a plurality of sections. FIGS. 3 and 4 show an example of a platform 36 that includes an aft section 36A and a forward section 36B. The present disclosure is not limited to any particular platform 36 configuration. In some embodiments, the platform 36 may be configured so that a forward section 36B can be pivoted upward; e.g., to allow the first and second side rails 32, 34 to be disposed on opposite sides of an item on the ground. The forward section 36B may be described as having a first end disposed adjacent the aft section 36A and an opposite distal end, wherein the first end of the forward section 36B is pivotally attached to the base 24 to permit the distal end of the forward section 36B to be selectively rotated between a platform position where the distal end of the forward section 36B is aligned with the first side rail and the second side rail (e.g., as shown in FIG. 3), and a stowed position wherein the distal end of the forward section 36b is rotated back towards the upright frame 25 (e.g., as shown in dashed lines in FIG. 1). In some embodiments (e.g., as shown in FIG. 4), the platform is a unitary body that may be described as having a first end 36C and an opposite distal end 36D, wherein the first end 36C of the platform 36 is pivotally attached to the base 24 to permit the distal end 36D to be selectively rotated between a platform position where the distal end 36D is aligned with the first and second side rails 32, 34 (as shown in FIG. 4), and a stowed position wherein the distal end 36D is rotated back towards the upright frame 25. With the platform 36 (or a forward section 36B) rotated back towards the upright frame 25, an item may be lifted directly from the ground. The embodiment shown in FIG. 4 has a platform 36 with its first end 36C attached to the base 24 by hinges. A plurality of wheels 38 are attached to the base 24 (e.g., to the side rails), configured to permit the cart 22 to be wheeled. In the embodiments shown in FIGS. 1-5, the base 24 includes four (4) wheels 38 (two aft and two forward). The present disclosure is not limited to having four wheels 38. Each wheel 38 has a wheel axis of rotation 40. In some embodiments, some of the wheels 38 may each respectively be disposed on a mount that allows the wheel 38 to rotate to change the orientation of the wheel's axis of rotation 40. The rotational wheel mounts allow the cart 22 to be pivoted; e.g., clockwise or counterclockwise. In some embodiments, one or more of the wheels 38 may include brakes that can be selectively applied to prevent rotation of the respective wheel. Load lifting devices 20 configured as a movable cart 22 are preferably configured to have a center of gravity with a load and without a load that inhibits tipping of the cart.

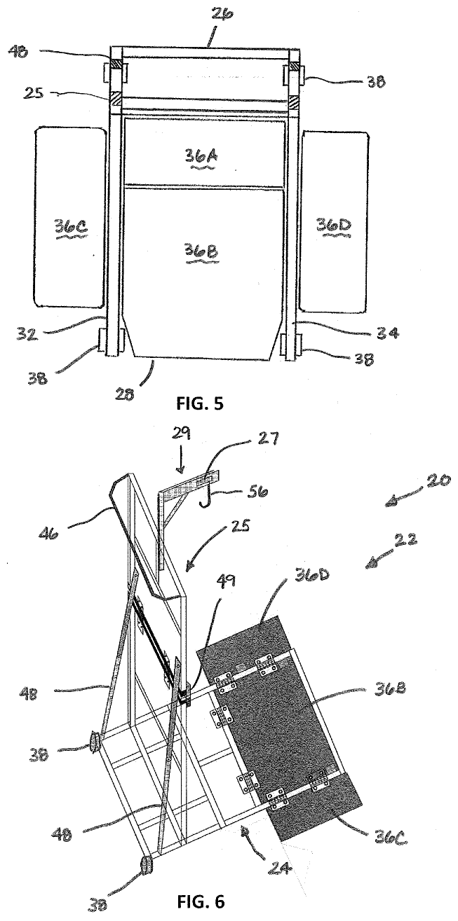

In some embodiments, the base 24 may include a platform extension on one or both lateral sides of the cart 22 to increase the platform 36 surface area on which items may be disposed during use of the cart 22. The non-limiting embodiments shown in FIGS. 5 and 6 include a first lateral side platform extension 36C and a second lateral side platform extension 36D. The platform extensions 36C, 36D may be configured for selective attachment and removal, or may be attached by hinges (e.g., see FIG. 6), or the like. The present disclosure is not limited to any particular platform extension attachment configuration.

The upright frame 25 includes a base end 42 and an upper end 44. The base end 42 of the upright frame 25 is attached to the base 24 and the upright frame 25 extends upwardly away from the base 24. The upright frame 25 may be disposed perpendicular to the base 24 or it may be disposed at an acute angle (“α”—see FIG. 1) relative to the base 24. In some embodiments, a handle 46 may be attached to the upright frame 25 at or near to the upper end 44 of the upright frame 25. In some embodiments, one or more support members 48 may extend between the base 24 and the upright frame 25 to support the upright frame 25 relative to the base 24. In some embodiments, the support members 48 may be selectively attachable/detachable, and/or may be configured to be foldable. For example, in some embodiments, the upright frame 25 may be configured to be foldable (e.g., two portions attached to one another by hinge) to permit the height of the upright frame 25 to be decreased for storage and/or transport. In these embodiments (and others), the one or more support members 48 extending between the base 24 and the upright frame 25 may be folded for storage or transport. In those embodiments that include a foldable upright frame 25, the upright frame 25 may include one or more members (e.g., brackets, braces, etc.) to support the upright frame 25 and prevent inadvertent folding; e.g., to prevent folding that may occur when a load is picked up. As a non-limiting example, the embodiment shown in FIG. 4 includes one or more braces 49 attached to a portion of the upright frame that inhibit folding or deflection of a portion of the upright frame from its operational configuration as shown in FIG. 4. Similar brace members may be used on other foldable components such as the support members 48. The present disclosure contemplates that a foldable member (e.g., the upright frame 25, the support members 48, etc.) may be configured to change from an operational configuration to a folded configuration in a variety of different ways (e.g., hinge connection, scissor connection, telescopic connection, etc.) and the present disclosure is not limited to any particular configuration. In addition, embodiments of the present disclosure may include a locking feature (e.g., a thumb screw, pins, biased feature, etc.) to lock the foldable member in an operational configuration. In some embodiments, a folded configuration may be achieved by an upright frame that is selectively detachable from the base. For example, the base 24 and the base end 42 of the upright frame 25 may have a mating male and female type connection that can be used to selectively attach the upright frame 25 to the base 24 (e.g., the operational configuration) or selectively detach the upright frame 25 from the base 24 (e.g., the folded configuration). In some embodiments, a folded configuration may be achieved by an upright frame 25 having at least two portions; e.g., a first portion that is attached to the base 24 and a second portion that is selectively detachable from the first portion. For example, the first and second portions of the upright frame 25 may have a mating male and female type connection that can be used to selectively attach the upper portion of the upright frame 25 to the lower portion of the upright frame 25 and therefore to the base 24 (e.g., the operational configuration) or selectively detach the upper portion of the upright frame 25 from the lower portion (e.g., the folded configuration). In these embodiments, the connection between the upright frame 25 and the base 24, or between the lower and upper portions of the upright frame 25 are purposefully attachable and detachable to permit ready assembly there between for transitioning between an operational configuration and a folded configuration.

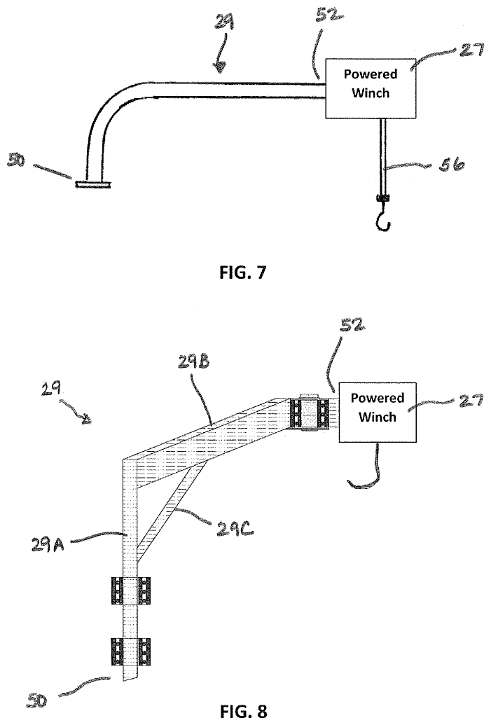

The winch arm 29 is attached to the upright frame 25 and has an attachment end 50 and a distal end 52. In the embodiment shown in FIG. 1, the attachment end 50 of the winch arm 29 is attached to the upper end 44 of the upright frame 25. Attaching the winch arm 29 to the upper end 44 of the upright frame 25 is one example of how the winch arm 29 may be attached and the present disclosure is not limited thereto. In the embodiments shown in FIGS. 1 and 6, the winch arm 29 includes a vertical portion 29A, a boom portion 29B, and a support 29C extending there between. The boom portion 29B extends from the vertical portion 29A to the distal end 52 of the winch arm 29. The present disclosure is not limited to this winch arm 29 embodiment. For example, in some embodiments the winch arm 29 may be a unitary structure having an arcuate portion that extends between the upright frame 25 and the boom portion 29B; e.g., see FIG. 7. In some embodiments, a portion of the winch arm 29 (e.g., the boom portion 29B) may be configured to be foldable (e.g., hinge in as shown in FIG. 8, or a bearing, or the like) to permit the length of the boom portion 29B to be decreased for storage and/or transport or for load positioning.

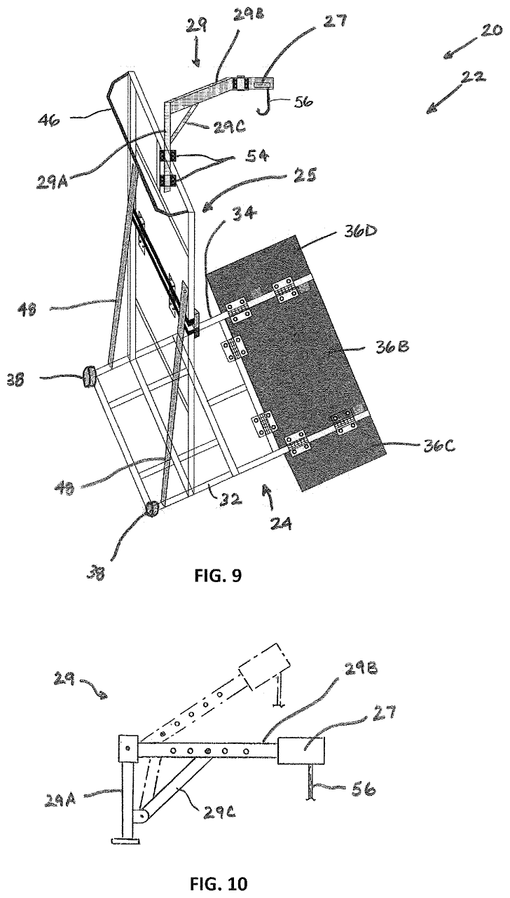

In some embodiments, the winch arm 29 may be attached to the upright frame 25 in a fixed manner (e.g., see FIG. 1). In some embodiments, the winch arm 29 may be pivotally attached to the upright frame 25 to permit the winch arm 29 to rotate laterally; e.g., FIG. 9 illustrates an embodiment wherein the winch arm 29 is pivotally attached by a pair of bearings 54. A pivotally mounted winch arm 29 enables the distal end 52 of the winch arm 29 to be pivoted toward either the first side rail 32 disposed on the first lateral side or the second side rail 34 disposed on the second lateral side. In some embodiments (see FIG. 10A), a portion of the winch arm 29 (e.g., the boom portion 29B) may be pivotally connected to permit adjustment of the vertical distance between the distal end 52 of the winch arm 29 and the base 24; e.g., either pivot the boom portion 29B upward to increase the distance between the distal end 52 and the base 24, or pivot the boom portion 29B downward to decrease the distance between the distal end 52 and the base 24. In some embodiments, the length of the boom portion 29B of the winch arm 29 may be adjustable. For example, the boom portion 29B may have one or more nested sections (e.g., telescopic) that can be pulled outward toward the forward end 28 of the base 24 and thereby move the distal end 52 of the winch arm 29 closer to the forward end 28 of the base 24 or collapsed inward (i.e., nested) to move the distal end 52 of the winch arm 29 further away from the forward end 28 of the base 24.

The powered winch 27 includes a lift line 56 that can be played out or drawn in; e.g., to pick up an item or to lower an item suspended from the lift line 56. The lift line 56 may be configured from a variety of different materials (e.g., various metals, or polymers, or organic materials, etc.) and the present disclosure is not limited to having a lift line 56 of any particular material. The winch 27 is connected to, or connectable to an electrical power source 58 and can be controlled in a plurality of different ways. The power source 58 may be a stored energy source (e.g., a battery) or the winch 27 may be configured for connection to a source of AC electrical power; e.g., a 110V electrical outlet, or both; e.g., if an AC source is available, the winch 27 may be plugged into the AC source and if an AC source is not available, the operator may switch the winch 27 to the stored energy source. The present disclosure is not limited to any particular type of stored electrical power source. As an example, the stored energy source may be a battery that is intended to stay with the cart 22, and may be configured for recharging, for example by being plugged into an AC source. As another example, the stored energy source may be a rechargeable lithium battery unit like those used with power tools. In some embodiments, the powered winch 27 may include a means for locking the lift line 56; e.g., a brake, or a gear box (e.g., a worm gear), or the like. The present disclosure embodiment shown in FIG. 1 depicts a powered winch 27 attached to the distal end 52 of the winch arm 29 and a battery attached to the upright frame 25 as a power source 58. The present disclosure is not limited to this configuration. For example, the powered winch 27 and battery may be attached to the base 24 adjacent the aft end 26 of the base 24, and the winch lift line 56 may be extended up to the distal end 52 of the winch arm 29 and guided by pulleys.

The controls for operating the powered winch 27 may take a variety of different forms. For example, the controls for operating the powered winch 27 may be mounted on the winch 27 itself. As another example, the controls for operating the winch 27 may be mounted on the upright frame 25 or on the handle 46 attached to the upright frame 25. In these examples and others, the controls may be connected by hardwire connected to the powered winch 27. As another example, the powered winch 27 may be controlled by a wireless control unit. As yet another example, the powered winch 27 may be controlled by a mobile device application (i.e., software that is designed to run on a mobile device such as a smartphone, often referred to as a “smartphone app”).

In some embodiments wherein the load lifting device 20 is configured as a movable cart 22, the movable cart 22 may be configured in an operational configuration (e.g., a configuration wherein the device 20 is set to be operated) and a storage configuration; e.g., a configuration where the device 20 can be collapsed or folded or the like into a smaller configuration that is more readily storable. The storage configuration may include the foldable winch arm 29, foldable upright frame 25, and/or foldable support members 48, or any combination thereof as described above.

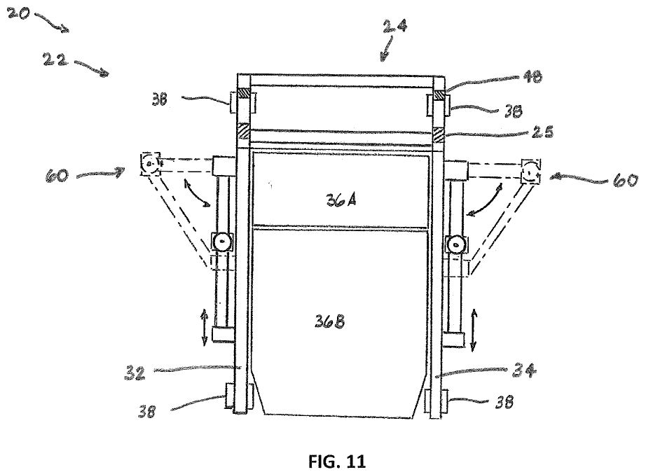

In some movable cart 22 embodiments, the cart 22 may include a plurality of outriggers 60 that extend laterally out beyond the first and second side rails 32, 34 to provide additional stability for the cart 22. The embodiment shown in FIG. 11, for example, includes collapsible outriggers 60 each having a wheel. FIG. 11 shows the collapsible outriggers 60 in a collapsed configuration in solid line, and shows the collapsible outriggers 60 in a deployed configuration in dashed line. The outrigger 60 configuration shown in FIG. 11 is provided as an example, and the present disclosure is not limited thereto.

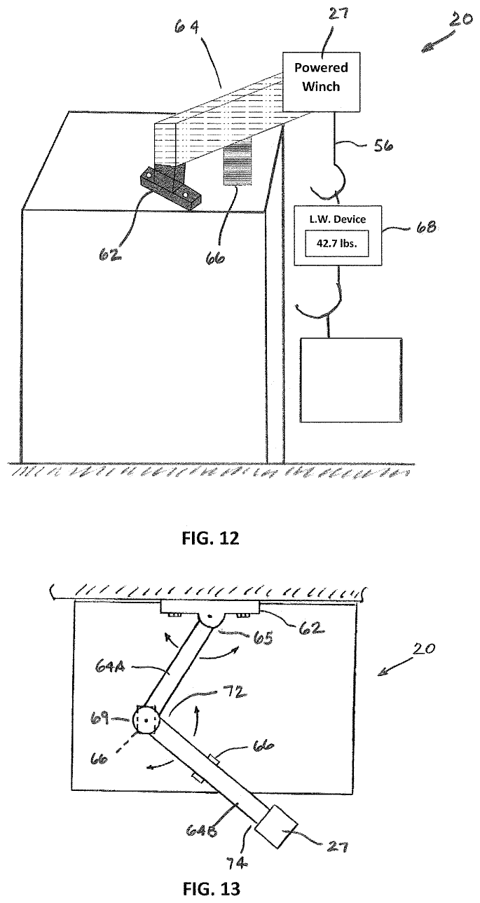

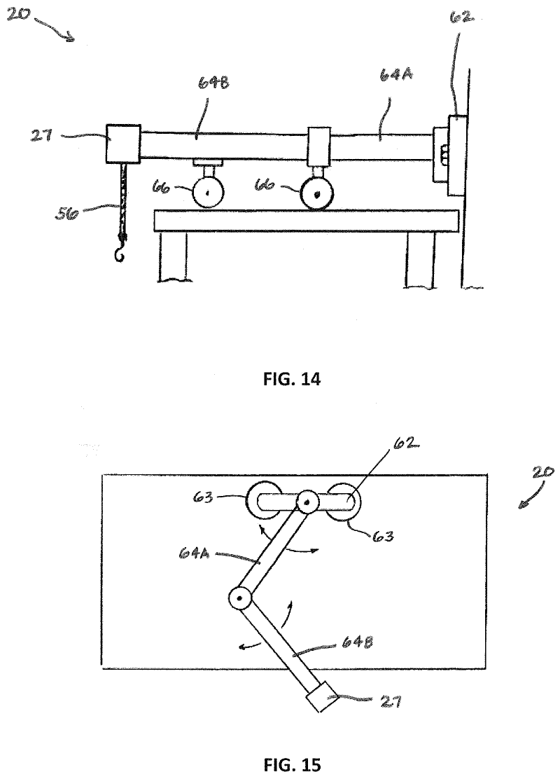

Referring to FIGS. 12-16, an embodiment of the load lifting device 20 includes an attachment base 62, at least one arm segment 64, and a powered winch 27. The attachment base 62 is configured to attach the load lifting device 20 to a stationary object such as a wall, or a table or countertop, or the like. The attachment base 62 may be configured to attach to the stationary object by magnetic attachment means, or by suction means (e.g., suction cups 63 as is diagrammatically shown in FIG. 15), by conventional means (e.g., fasteners as shown in FIGS. 12-14), or the like.

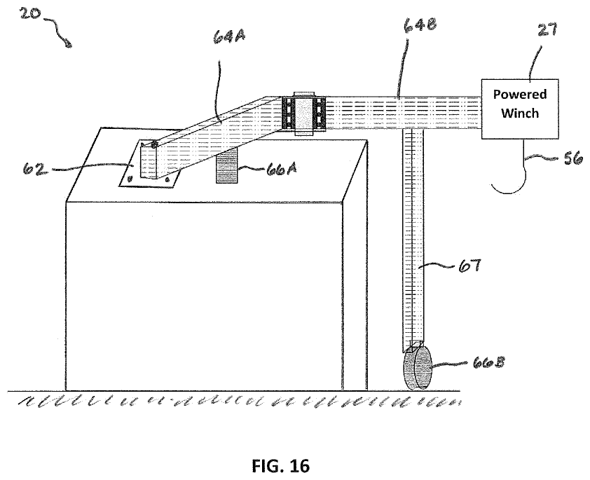

The at least one arm segment 64 is pivotally attached to the attachment base 62. The embodiment shown in FIG. 12 has a single arm segment 64. The embodiments shown in FIGS. 13-16 include a first arm segment 64A and a second arm segment 64B. The first arm segment 64A may be described as extending lengthwise between a first end 65 and a second end 69, and the second arm segment 64B may be described as extending lengthwise between a first end 72 and a second end 74. The first end 65 of the first arm segment 64A is pivotally attached to the attachment base 62 and the second end 69 of the first arm segment 64A and the first end 72 of the second arm segment 64B are pivotally attached to one another. The articulated configuration of the arm segments 64A, 64B permits a multi-dimensional degree of movement. In some embodiments, the length of an arm segment 64, 64A, 64B may be adjustable. For example, an arm segment 64, 64A, 64B may have one or more nested sections (e.g., telescopic) that can be pulled outward to extend the length of the arm segment 64, 64A, 64B or collapsed inwardly (i.e., “nesting” the sections) to decrease the length of the arm segment 64, 64A, 64B. In some embodiments, the load lifting device 20 may include one or more rollers 66 (or stationary bushings, or other supports, etc.—which may be collectively referred to as a “moveable support”) to support the one or more arm segments 64 relative to a table or other horizontal surface. For example, in the single arm segment 64 configuration of FIG. 12, a single roller 66 is used. In the embodiment shown in FIGS. 13-15, a pair of rollers 66 are used to support the first and second arm segments 64A, 64B relative to an elevated surface. In the embodiment shown in FIG. 16 a first roller 66A is used to support the first arm segment 64A relative to an elevated surface and a second roller 66B (attached to a support member 67) is used to support the second arm segment 64B relative to the ground. In those embodiments that include a roller 66 (or other support), the present disclosure is not limited to using any particular number of rollers 66 and is not limited to positioning the rollers 66 is any particular position. In some embodiments, the position of a roller relative to an arm segment 64A, 64B may be adjustable to facilitate operation of the load lifting device 20. The rollers 66 (and/or other moveable supports) provide both support to the respective arm segment and facilitate movement (e.g., swiveling, rotation, etc.) of the respective arm segment. In some embodiments, one or more of the rollers 66 may include a braking device to facilitate holding the arm segment in a particular position. The present disclosure is not limited to these roller 66 examples.

The powered winch 27 is attached to an arm segment 64, 64B. For example, in the embodiments shown in FIG. 12, the powered winch 27 is attached to a distal end of the sole arm segment 64 and in FIGS. 13-16, the powered winch 27 is attached to a distal end of the second arm segment 64B. The attachment of the powered winch 27 to the distal end of the second arm segment 64B coupled with the articulated nature of the first and second arm segments 64A, 64B gives these embodiments of the present disclosure considerable ability to position the powered winch 27 in a two-dimensional plane, and consequently considerable ability to pick up an item at a first location and allow its movement to a second location, or vice versa. The powered winch 27 and the power source 58 may be configured as described above.

Some embodiments of the present disclosure are configured to determine the weight of the item being picked up. For example, a load weighing device 68 (“L.W. Device”—e.g., see FIG. 12) may be in communication with the lift line 56. The load weighing device 68 may include a display indicating the weight of the item lifted and/or may be configured to communicate the determined weight to a remote display; e.g., communicate to a mobile device app. In some embodiments, the powered winch 27 may be configured to determine the weight of the item being lifted. The powered winch 27 may include a display indicating the weight of the item lifted and/or may be configured to communicate the determined weight to a remote display; e.g., communicate to a mobile device app. The present disclosure is not limited to the above examples of load weighing devices or means for measuring a load applied to the lift line 56.

As stated above, some embodiments of the present disclosure may include communications with a mobile device app or other software package that is configured to produce “documentation” (e.g., a displayed value of the item weight, or a print copy of the same). In some embodiments, operational control of the powered winch 27 may be accomplished through the mobile device app.

While the principles of the disclosure have been described above in connection with specific apparatuses, it is to be clearly understood that this description is made only by way of example and not as limitation on the scope of the disclosure. Specific details are given in the above description to provide a thorough understanding of the embodiments. However, it is understood that the embodiments may be practiced without these specific details.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

Additionally, even though some features, concepts, or aspects of the disclosures may be described herein as being a preferred arrangement or method, such description is not intended to suggest that such feature is required or necessary unless expressly so stated. Still further, exemplary, or representative values and ranges may be included to assist in understanding the present application, however, such values and ranges are not to be construed in a limiting sense and are intended to be critical values or ranges only if so expressly stated.

1. A load lifting device, comprising:
a cart having a base with a plurality of rollers, the base having a forward end and an aft end, an upright frame having a base end and a distal upper end, the base end of the upright frame attached to the base proximate the aft end, and a winch arm extending out from the upright frame proximate the upper end;
a powered winch that is controllable to selectively play out or draw in a lift line, the powered winch attached to the winch arm and is in communication with a source of electrical power; and
controls configured for operating the powered winch to play out or draw in the lift line.

2. The load lifting device of claim 1, wherein the cart is configurable in an operational configuration wherein an entirety of the upright frame extends upwardly from the base, and in a folded configuration wherein less than the entirety of the upright frame extends upwardly from the base.

3. The load lifting device of claim 2, wherein the upright frame includes a first portion attached to the base and a second portion attached to the first portion by one or more foldable joints.

4. The load lifting device of claim 1, further comprising one or more support members extending between the upright frame and the base adjacent the aft end, wherein the one or more support members are selectively detachable from the base and upright frame.

5. The load lifting device of claim 1, further comprising one or more support members extending between the upright frame and the base adjacent the aft end, wherein the one or more support members include a foldable joint.

6. The load lifting device of claim 1, wherein the winch arm includes an attachment end and a distal end, and the attachment end is pivotally attached to the upright frame to permit the distal end of the winch arm to selectively be moved laterally towards a first lateral side of the base or to a second lateral side of the base, wherein the second lateral side of the base is opposite the first lateral side.

7. The load lifting base of claim 1, wherein the base includes a first side rail disposed on a first lateral side of the base, a second side rail disposed on a second lateral side of the base, wherein the first lateral side of the base is opposite the second lateral side of the base, and a platform extends between the first side rail and the second side rail.

8. The load lifting device of claim 7, wherein the platform includes an aft section and a forward section, the forward section having a first end disposed adjacent the aft section and an opposite distal end, wherein the first end of the forward section of the platform is pivotally attached to the base to permit the distal end of the forward section to be selectively rotated between a platform position where the distal end of the forward section is aligned with the first side rail and the second side rail, and a stowed position wherein the distal end of the forward section is rotated back towards the upright frame.

9. The load lifting device of claim 7, wherein the platform includes a first end and a distal end, and the first end is pivotally attached to the base to permit the distal end of the platform to be selectively rotated between a platform position where the distal end of the platform is aligned with the first side rail and the second side rail, and a stowed position wherein the distal end of the platform is rotated back towards the upright frame.

10. The load lifting device of claim 7, wherein the base further includes at least one platform extension disposed on the first lateral side of the base and extending laterally outward from the first side rail, or disposed on the second lateral side of the base and extending laterally outward from the second side rail.

11. The load lifting device of claim 7, wherein the base further includes a first platform extension disposed on the first lateral side of the base and extending laterally outward from the first side rail, and a second platform extension disposed on the second lateral side of the base and extending laterally outward from the second side rail.

12. The load lifting device of claim 1, wherein the source of electrical power is a portable source of stored electrical power.

13. The load lifting base of claim 1, wherein the base includes a first lateral side and a second lateral side, wherein the first lateral side is opposite the second lateral side; and
the device further comprises a first outrigger disposed on the first lateral side and a second outrigger disposed on the second lateral side.

14. The load lifting device of claim 1, further comprising a load weighing device configured to determine a magnitude of a load lifted by the powered winch.

15. A load lifting device, comprising:
an attachment base configured for selective attachment to a surface;
at least one arm segment pivotally attached to the attachment base;
a powered winch attached to the at least one arm segment, the powered winch is controllable to selectively play out or draw in a lift line and is in communication with a source of electrical power; and
controls configured for operating the powered winch to play out or draw in the lift line.

16. The load lifting device of claim 15, further comprising at least one moveable support attached to the at least one arm segment, the at least one moveable support configured to support the at least one arm segment.

17. The load lifting device of claim 15, wherein the at least one arm segment includes a first arm segment (FAS) and a second arm segment (SAS), wherein the FAS extends lengthwise between a FAS first end and a FAS second end, and the SAS extends lengthwise between a SAS first end and a SAS second end, wherein the FAS first end of the FAS is pivotally attached to the attachment base and the FAS second end is pivotally attached to the SAS first end of the SAS, and the powered winch is attached to the SAS.

18. The load lifting device of claim 17, further comprising at least one moveable support attached to the FAS or the SAS, the at least one moveable support configured to support at least one of the FAS or the SAS.

19. The load lifting device of claim 17, wherein said at least one moveable support includes at least one roller attached to the FAS and at least one roller attached to the SAS.

20. The load lifting device of claim 15, further comprising a load weighing device configured to determine a magnitude of a load lifted by the powered winch.
